(19) United States
(12) Patent Application Publication
(10) Pub. No.: US 2005/0246411 A1
(43) Pub. Date: Nov. 3, 2005

(54) Method and apparatus for direct signaling of e-mail messages in response to faults

(76) Inventor: James B. Vitrano, South Milwaukee, WI (US)

Correspondence Address: Susan M. Donahue;Rockwell Automation, Inc., 704-P, 1201 South Second Street, Milwaukee, WI, 53204, US

(21) Appl. No.: 10/837,798

(22) Filed: May 3, 2004

(51) Int. Cl. G06F 15/16

(52) U.S. Cl. 709/200

(57) ABSTRACT

A network adapter (12) for connecting a motor drive (11) to a network (13) comprises a microelectronic CPU (17) for executing a control program (22) and a program memory (20) for storing the control program (22). The control program (22) includes instructions for generating screen displays including configuration screen displays (50, 60) for selecting a plurality of specific fault conditions to be monitored at the motor drive (11), and the screen displays include locations (45, 67) for entering a network address for sending an e-mail message (71) in response to a fault condition. The control program (22) includes further instructions for generating the e-mail message (71) to the entered network address in response to occurrence of at least one of the selected faults. A method of practicing the invention is also disclosed.

### CROSS-REFERENCE TO RELATED APPLICATIONS

NOT APPLICABLE

### STATEMENT REGARDING FEDERALLY SPONSORED RESEARCH

NOT APPLICABLE

### TECHNICAL FIELD

The fields of the invention are electronic motor controls known as motor drives and computer networks which can be connected to such motor drives.

### BACKGROUND ART

In factory automation and other commercial applications requiring control of motors, the control electronics is packaged in a unit known as a “motor drive.” This unit may have a microelectronic CPU as well as other circuitry mounted on one or more circuit boards. This unit also typically has a keyboard for entering commands and data, and a display for reading out status data concerning the motor.

Such status data may include diagnostic and condition data, which would signal a technical problem with the motor or its control system, and such a technical problem shall be referred to herein as a “fault.” The term “fault” in this instance refers to a problem or condition including alarm conditions, rather than being limited to electric voltage or current faults, although it also includes such problems.

In the prior art, it has been known to generate e-mail messages to a personal computer as a result of problems with a motor or other electrical device. Examples are provided in Johnson et al., U.S. Pat. No. 6,553,336; Sandelman et al., U.S. Pat. No. 6,147,601 and Conkright et al., U.S. Pat. Pub. No. 2003/0126258, published Jul. 3, 2003.

In these systems, a mail server computer is configured to generate e-mail messages, faxes or other messages in response to various types of malfunction conditions. Often, these systems envision a local area wireless network coupled to a wide area network, such as the Internet.

In the environment of motor drives, a lower cost, more convenient solution with greater flexibility is desired in lieu of the systems described above.

### SUMMARY OF THE INVENTION

The invention relates to a method and a circuit in the form of a network adapter card that can be attached to a motor drive unit and set up using standard computer hardware and software. This avoids the need to provide custom software for an Internet/Intranet server as seen in the prior art.

The invention provides a device that can be configured with a Web browser interface that can be opened on a computer connected to the motor drive through an Intranet-type (private) Ethernet network. Although Ethernet is a preferred network, other types of networks might also be employed.

The Ethernet adapter card is provided with a computer program that will generate a sequence of browser configuration screens, as well as generating an e-mail message to a computer address on the network when a fault of the type being monitored occurs.

In addition, the invention provides additional monitoring features such as a live, refreshable status screen of motor operation, all within a familiar Web browser interface.

It is one object of the invention to provide a solution to motor fault monitoring that does not require specialized software or configuration of servers on the network.

It is another object of the invention to provide a low-cost convenient solution to adding e-mail fault messaging capability. Adapter cards are required to connect the motor drives to an Ethernet network and by customizing such adapter cards, a low-cost convenient solution is provided.

These and other objects and advantages of the invention will be apparent from the description that follows and from the drawings which illustrate embodiments of the invention, and which are incorporated herein by reference.

### BRIEF DESCRIPTION OF THE DRAWINGS

FIG. 1 is a block diagram of a network incorporating a motor drive network adapter of the present invention;

FIG. 2 is a detailed block diagram of the motor drive network adapter of the present invention seen in FIG. 1;

FIG. 3 is a home page display generated in a browser window on a personal computer seen in FIG. 1;

FIG. 4 is a configuration of e-mail fault reporting screen display generated in a browser of the personal computer seen in FIG. 1;

FIGS. 5 and 6 are two portions of a screen display window called up through the screen display in FIG. 4;

FIG. 7 is an alternate configuration screen display to that shown in FIGS. 5 and 6; and

FIG. 8 is a e-mail fault reporting message received on a personal computer such as seen in FIG. 1; and

FIG. 9 is a live status motor monitoring window called up through the home page screen display seen in FIG. 3.

### DETAILED DESCRIPTION

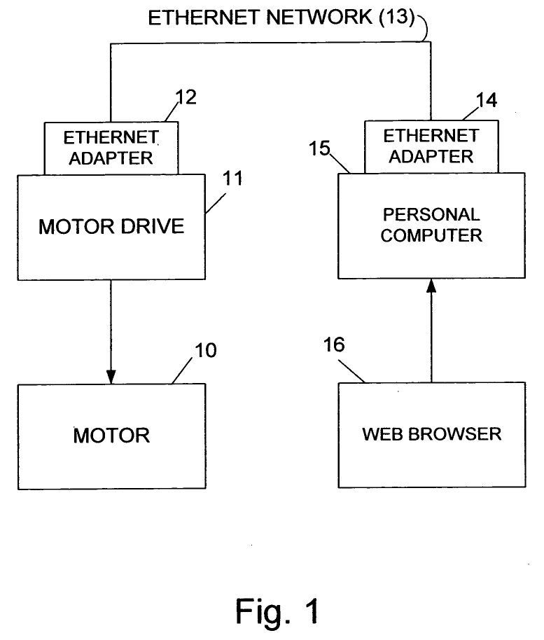

FIG. 1 shows a system that incorporates the present invention including an electric motor 10 to be controlled by an electronic known as a motor drive 11. It should also be understood that a generator could be controlled, and that the term “electric machine” shall be used to mean either an electric motor or an electric generator. The motor drive 11 is provided with an Ethernet adapter module 12, which can be internal or external. Ethernet adapter cards are well known add-on cards in the computer arts for allowing computers to communicate on Ethernet networks. A typical Ethernet adapter card 14 is provided here for interfacing a conventional personal computer 15 to the Ethernet network 13. This network 13 includes at least one SMTP (simple mail transfer protocol) server (not shown). A particular feature of the present invention is that it operates in co-operation with commercially available, off-the-shelf, computer equipment 15, 16, running a conventional application type of computer program 16. In the preferred embodiment, this is an Internet browser type of program, although in other embodiments, application programs with an e-mail component might be used. In the present example, the Ethernet network 13 operates like the Internet, except that for security reasons, it preferred to be an Intranet or private network, not accessible to users outside the company. The invention is provided in a customized or value-added Ethernet adapter 12 for the motor drive 11.

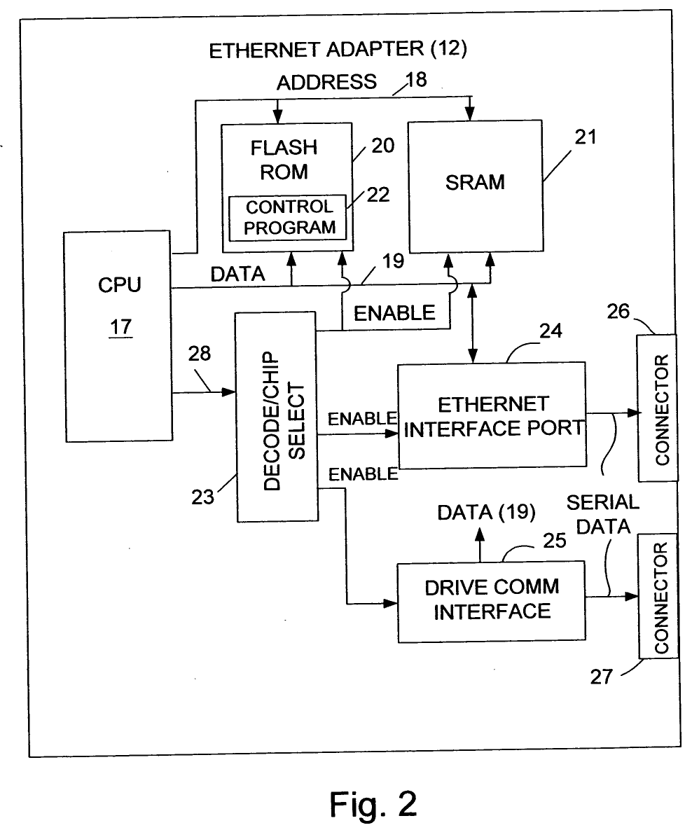

Referring to FIG. 2, the Ethernet adapter 12 more particularly includes a microelectronic CPU 17 that is connected through an address bus 18, a data bus 19 and a control bus 28 to other circuitry on a circuit board. The CPU 17 is aided in communicating and controlling the other circuitry by a decode/chip enable circuit in the form of a logic array circuit 23. The circuitry to be controlled includes a program memory 20 in the preferred form of a flash ROM of 2 Megabytes, a static RAM (SRAM) 21, an Ethernet interface port 24 and a drive communication port 25. The Ethernet interface port 24 provides serial data through a connector 26 to the Ethernet network 13. The drive communication port 25 provides serial data through a connector 27 to the motor drive 11. This communication could also be carried on as parallel data in other embodiments, particularly where the adapter was integrated with the circuitry in the motor drive 11.

The adapter 12 is provided with a control program 22, which is stored in the program memory 20. The control program 22 includes program instructions, usually in a compiled form, to be executed by the CPU 17 to carry out the operations to be described. In particular, the control program 22 includes instructions for generating screen displays in a general purpose Internet browser application 16 operating on a personal computer 15 connected to the network adapter through the network 13 as shown in FIG. 1.

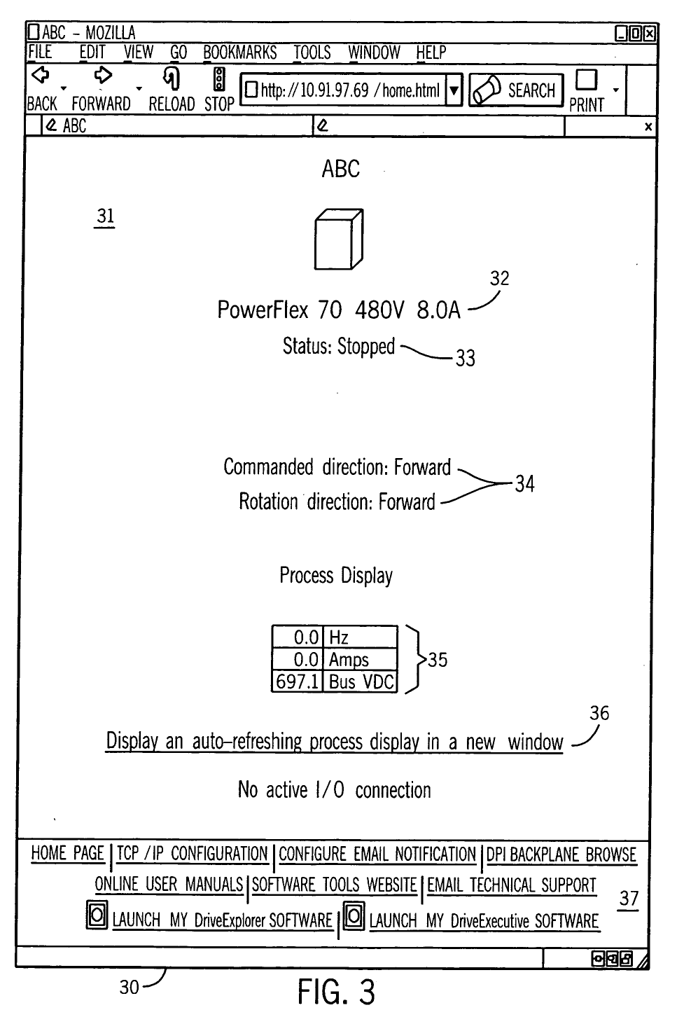

Referring next to FIG. 3, when the motor drive is addressed at a network address such as 10.91.97.69 as seen in FIG. 3, a home page 31 is displayed in a browser window 30 on a screen of the personal computer 15. Each page includes a command portion 37 reserved for hypertext links to other screen displays. In the home page portion 31 the drive 11 is identified by model number (PowerFlex 70), and electrical rating size (480V, 8.0A) in line 32. Below is a line 33 showing a general status and below that are two display lines (display fields) 34 showing the direction of rotation as commanded and as actually occurring. Below that on the home page 31 is a process display area 35 showing the electrical parameters of operation such as dc bus volts, amps and frequency (Hz). Below that is a hypertext link 36 to an auto-refresh status screen to be described later herein.

When it is desired to configure or select the faults to be reported with this system, the link entitled, “Configure E-mail Notification” is selected in the command portion 37 of the screen display 30.

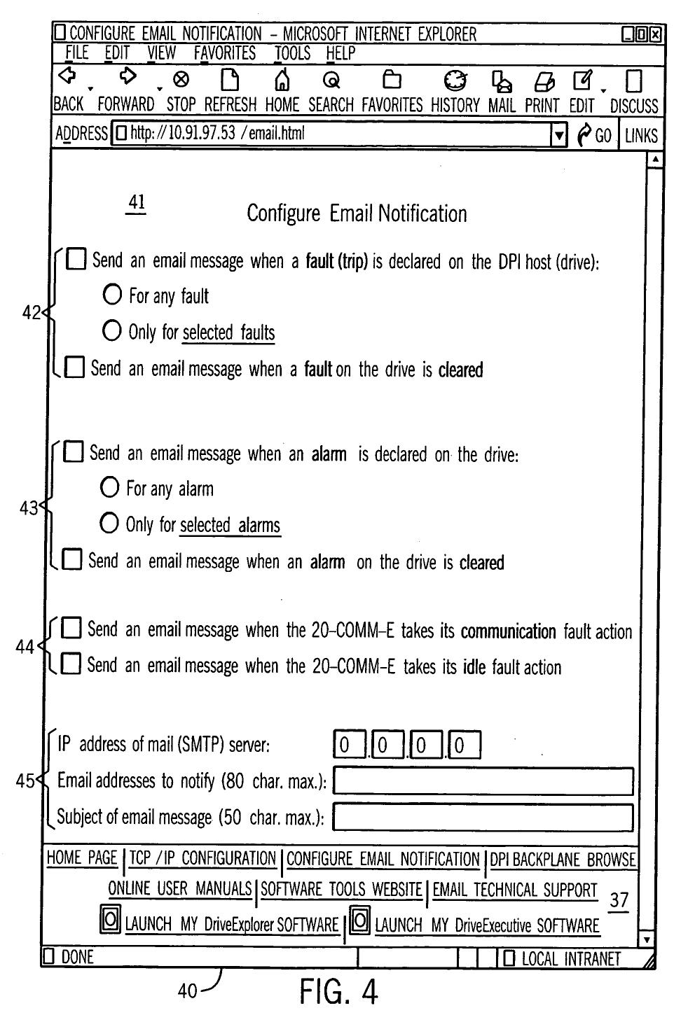

This causes the network adapter 12 to send the personal computer 15, suitable data to displaying the screen display window 40 seen in FIG. 4. This window 40 includes the configure e-mail notification page 41 along with the command area 37. The first four lines or fields 42 of this page 41 provide a combination of four check box and radio button selections to enable the sending of e-mail messages for any fault or for selected faults, as well as when the fault is cleared.

The next four lines or fields 43 of this page 41 provide a combination of four check box and radio button selections to enable the sending of e-mail messages for any alarm or for selected alarms, as well as when an alarm condition is cleared. For purposes of the claims herein, it shall be considered that the term “faults” includes alarm conditions.

The next two lines or fields 44 of this page 41 provide two check box selections to select sending an e-mail message when the drive 11 takes a communication fault action or when the drive 11 takes an idle fault action.

The area 45 below that includes data entry boxes for entering an SMTP server address on the network and an e-mail address for the personal computer to which a message will be sent in response to a fault condition, as well as an e-mail subject line for the message.

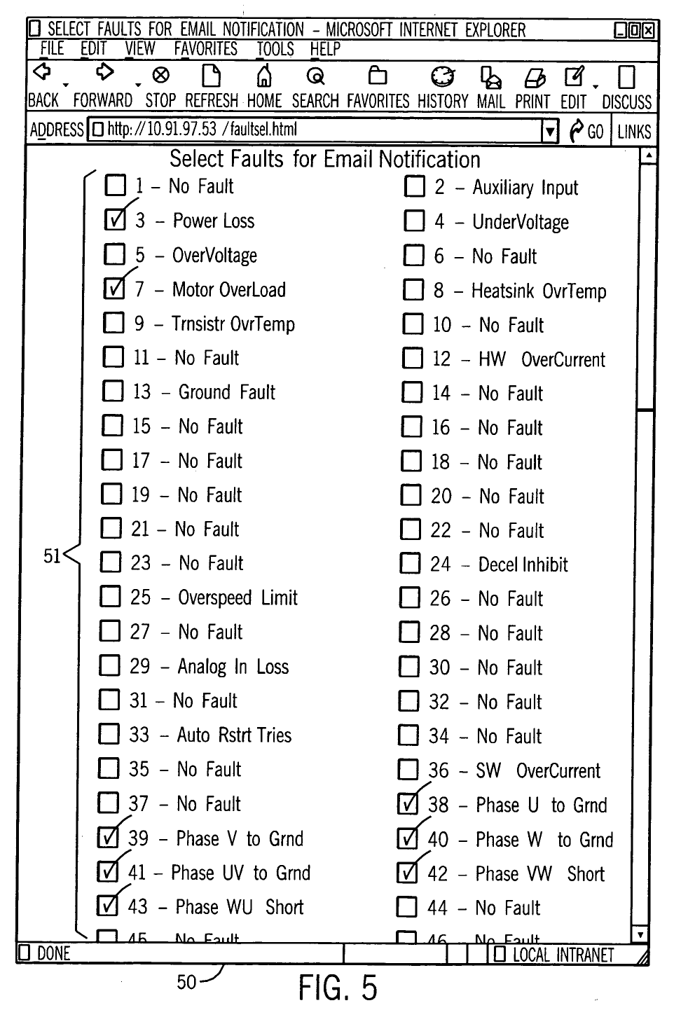

Assuming that that the first line and the third line, the “only selected faults” line, are checked in the first four lines or fields 42 of page 41, and the “selected faults” hypertext link is activated, then the network adapter 12 sends data to the web browser 16 so that the screen display 50 seen in FIGS. 5 and 6 is called up and displayed on the personal computer 15. The display 50 contains a long list, in two columns, of check boxes and legends denoting a code number and a fault condition name for each fault. Some fault code numbers have not been assigned as shown by the legend “no fault.” Assuming that boxes for code numbers 3, 7, 38 to 43 were checked, the e-mail messages would be sent when any of these faults occurred. E-mail messages would not be sent if faults occurred for boxes that have not been checked. In particular, it is noted that code number “81” in FIG. 6 has been checked.

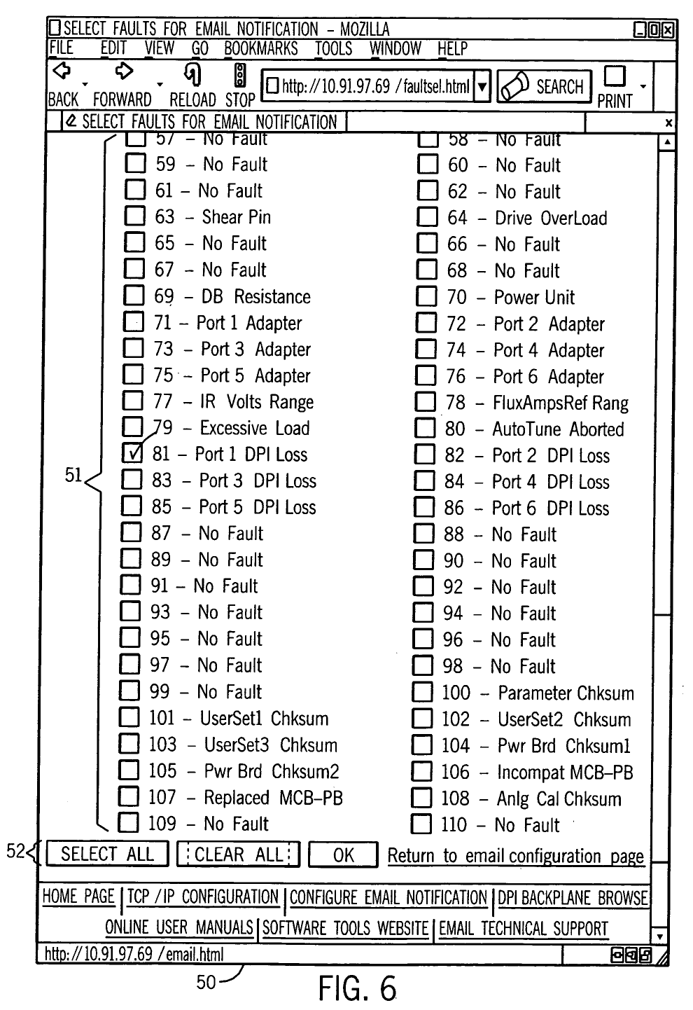

FIG. 7 shows a configuration screen display 60 which is an alternative to that in FIG. 4, which is called up when the configure Email notification link is selected in area 37 of the screen display 30 in FIG. 3. This screen display 60 includes fields 61-67, including data entry boxes for entering specific faults for generating the e-mail messages in field 61, a check box 62 for sending a message when the fault is cleared, data entry box fields 63 for selecting warning conditions, a check box field 64 for sending a message when a warning condition is cleared, check box fields 65 and 66 for sending e-mails for other events and data entry boxes for entering the network address where the messages are to be sent.

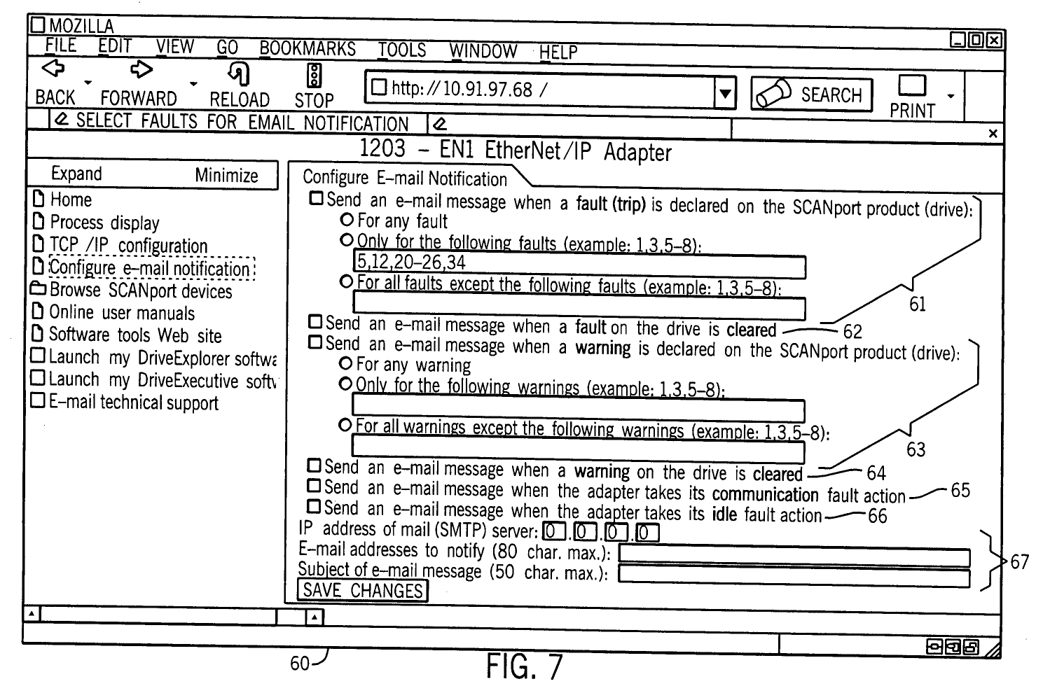

FIG. 8 illustrates an e-mail message 71 that is sent by the adapter 12 when a fault represented by code “81” occurs. This message 71 is displayed in a window 70 in a Lotus Notes application program running on the personal computer 15. The sending of the e-mail from the adapter 12 to the computer 15 is carried out by executing instructions in the control program 22 in FIG. 2, as are the other operations described above.

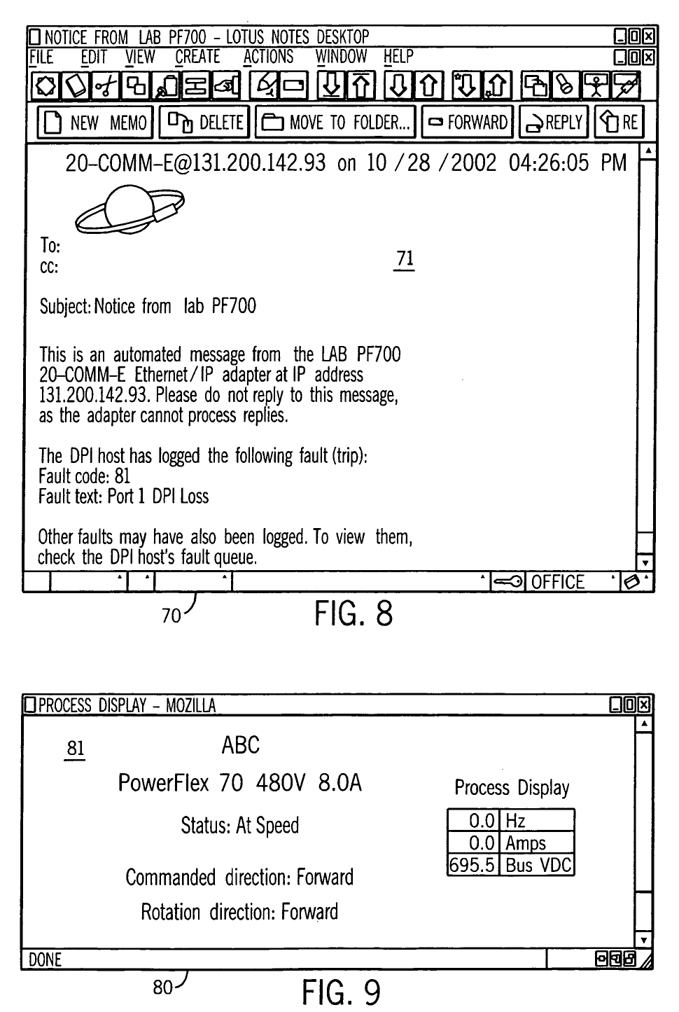

FIG. 9 illustrates an additional feature of the home page 31 seen in FIG. 3. If link 36 is selected the screen display and window 80 is displayed on a screen of the personal computer 15. This screen 81 is automatically and rapidly refreshed to present a live picture of motor operating conditions.

To summarize, the invention provides a method and circuit in form of a network adapter card that can be attached to a motor drive unit and set up using standard computer hardware and software. This avoids the need to provide software for an Internet/Intranet server as seen in the prior art.

The invention provides a device that can be configured with a Web browser interface that can be opened on a computer connected to the motor drive through an Intranet-type (private) Ethernet network. Although Ethernet is a preferred network for its high speed of data transfer and usability in both industrial and office environments, other types of networks might also be employed.

The adapter card is provided with a computer program that will generate a sequence of browser configuration screens, as well as generating an e-mail message to a computer address on the network, when a fault of the type being monitored occurs.

In addition, the invention provides additional monitoring features such as a live, refreshable status screen of motor operation, all within a familiar Web browser interface.

The invention provides a solution to motor fault monitoring that does not require specialized software or configuration of servers on the network.

This has been a description of several preferred embodiments of the invention. It will be apparent that various modifications and details can be varied without departing from the scope and spirit of the invention, and these are intended to come within the scope of the following claims.

1. A network adapter for interfacing an electric machine drive to a network, the network adapter comprising:
a microelectronic CPU for executing a control program;
a program memory for storing the control program;
wherein the control program includes instructions for generating screen displays on a personal computer connected to the network adapter through the network;
wherein the screen displays include configuration screen displays for selecting a plurality of specific fault conditions to be monitored at the electric machine drive;
wherein the screen displays include at one least field for entering a network address for sending a message in response to a fault condition; and
wherein the control program includes further instructions for generating the e-mail message to the entered network address in response to occurrence of at least one of the selected fault conditions.

2. The network adapter of claim 1, wherein the network is an Ethernet network.

3. The network adapter of claim 1, wherein the configuration screen displays provide a list of check boxes for selecting specific fault conditions to be monitored for generation of an e-mail fault message.

4. The network adapter of claim 1, wherein the configuration screen displays provide data entry boxes for selecting specific fault conditions to be monitored for generation of an e-mail fault message.

5. The network adapter of claim 1, wherein the control program includes further instructions for generating an automatically refreshed data screen on the personal computer connected to the network adapter through the network.

6. A method of e-mail fault reporting for electric machine drives comprising:
opening a general purpose application program on a personal computer;
connecting to an adapter on a electric machine drive unit through a computer communications network;
calling up a configuration screen display;
specifying an address for the e-mail notification on the network; and
selecting specific faults for which an e-mail fault message will be transmitted on the network to at least one monitoring computer; and
communicating the address for the e-mail notification and the specific faults to the adapter on the electric machine drive.

7. The method of claim 6, wherein the network is an Ethernet network.

8. The method of claim 6, wherein the network is a private network that is not accessible by the public.

9. The method of claim 6, wherein the configuration screen displays provide a list for selecting specific fault conditions to be monitored for generation of an e-mail fault message.

10. The method of claim 6, wherein the configuration screen displays provide data entry boxes for selecting specific fault conditions to be monitored for generation of an e-mail fault message.

11. The method of claim 6, further comprising the adapter transmitting an e-mail fault notification to the personal computer, upon an occurrence of one of the selected fault conditions.

12. The method of claim 6, wherein the control program includes further instructions for generating an automatically refreshed data screen on the personal computer connected to the network adapter through the network.

13. The method of claim 6, wherein neither customized programming nor configuration is required of network servers on the network to cause the e-mail fault message to be transmitted to the personal computer.

14. The method of claim 6, wherein the general purpose application program having e-mail capability is an Internet web browser program.
